(19) United States
(12) Patent Application Publication
(10) Pub. No.: US 2024/0311808 A1
(43) Pub. Date: Sep. 19, 2024

(54) SYSTEM AND METHOD FOR GENERATING INDIVIDUAL RECORDS ACROSS MULTIPLE DEVICES VIA AN ULTRA-WIDEBAND CONNECTION

(71) Applicant: BANK OF AMERICA CORPORATION, Charlotte, NC (US)

(72) Inventors: Maneesh Sethia, Hyderabad (IN); Shailendra Singh, Thane West (IN)

(73) Assignee: BANK OF AMERICA CORPORATION, Charlotte, NC (US)

(21) Appl. No.: 18/122,856

(22) Filed: Mar. 17, 2023

(51) Int. Cl. G06Q 20/38

(52) U.S. Cl. CPC G06Q 20/3821

(57) ABSTRACT

Systems, computer program products, and methods are described herein for generating individual records across multiple devices via an ultra-wideband connection. The method includes receiving a transfer request associated with a user. The method also includes determining a first transfer device. In an instance in which a first transfer device amount of the resource is less than the one or more units of the resource indicated by the transfer request, the method also includes determining a second transfer device. The method further includes creating a first transfer device non-fungible token for the first transfer device and a second transfer device non-fungible token for the second transfer device. A cumulative of the resource indicated by the first transfer device non-fungible token and the second transfer device non-fungible token are less than or equal to the one or more units of the resource indicated by the transfer request.

### TECHNOLOGICAL FIELD

Example embodiments of the present disclosure relate generally to generating individual records across multiple devices and, more particularly, to generating individual records across multiple devices via an ultra-wideband connection.

### BACKGROUND

Finding devices that are capable of completing large scale transfers can often be difficult. Through applied effort, ingenuity, and innovation, many of these identified problems have been solved by developing solutions that are included in embodiments of the present disclosure, many examples of which are described in detail herein.

### SUMMARY

The following presents a simplified summary of one or more embodiments of the present disclosure, in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments of the present disclosure in a simplified form as a prelude to the more detailed description that is presented later.

In an example embodiment, a system for generating individual records across multiple devices via an ultra-wideband connection is provided. The system includes at least one non-transitory storage device and at least one processing device coupled to the at least one non-transitory storage device. The at least one processing device is configured to receive a transfer request associated with a user. The transfer request includes a request for a one or more units of a resource from an account associated with the user. The at least one processing device is also configured to determine a first transfer device based on a location of the user. A first transfer device amount corresponds to an amount of the resource available for transfer from the first transfer device. The at least one processing device is further configured to determine a second transfer device based on the location of the user in an instance in which the first transfer device amount of the resource is less than the one or more units of the resource indicated by the transfer request. A second transfer device amount corresponds to an amount of the resource available for transfer from the second transfer device. The at least one processing device is still further configured to create a first transfer device non-fungible token for the first transfer device and a second transfer device non-fungible token for the second transfer device. The first transfer device non-fungible token indicates a portion of the one or more units of the resources indicated by the transfer request to be transmitted by the first transfer device and the second transfer device non-fungible token indicates a portion of the one or more units of the resources indicated by the transfer request to be transmitted by the second transfer device. A cumulative of the resource indicated by the first transfer device non-fungible token and the second transfer device non-fungible token are less than or equal to the one or more units of the resource indicated by the transfer request.

In various embodiments, the at least one processing device is also configured to determine one or more additional transfer device in an instance in which the cumulative of the resource indicated by the first transfer device non-fungible token and the second transfer device non-fungible token are less than the one or more units of the resource indicated by the transfer request. In various embodiments, the at least one processing device is also configured to create an additional transfer device non-fungible token for each of the one or more additional transfer device. Each additional transfer device non-fungible token includes a number of units of the resource to be transferred.

In various embodiments, the at least one processing device is also configured to cause a transmission of the first transfer device non-fungible token to the first transfer device and a transmission of the second transfer device non-fungible token to the second transfer device. In various embodiments, the at least one processing device is also configured to cause a transfer of the resource to the user at the first transfer device based on the first transfer device non-fungible token.

In various embodiments, the first transfer device non-fungible token and the second transfer device non-fungible token are accessible to the first transfer device and the second transfer device across a distributed network. In various embodiments, the at least one processing device is also configured to cause a transmission of an access code to a device associated with the user to be used to access at least one of the first transfer device or the second transfer device with the access code corresponding to at least one of the first transfer device non-fungible token or the second transfer device non-fungible token.

In another example embodiment, a computer program product for generating individual records across multiple devices via an ultra-wideband connection is provided. The computer program product includes at least one non-transitory computer-readable medium having computer-readable program code portions embodied therein. The computer-readable program code portions include an executable portion configured to receive a transfer request associated with a user. The transfer request includes a request for a one or more units of a resource from an account associated with the user. The computer-readable program code portions also include an executable portion configured to determine a first transfer device based on a location of the user. A first transfer device amount corresponds to an amount of the resource available for transfer from the first transfer device. The computer-readable program code portions further include an executable portion configured to determine a second transfer device based on the location of the user in an instance in which the first transfer device amount of the resource is less than the one or more units of the resource indicated by the transfer request. A second transfer device amount corresponds to an amount of the resource available for transfer from the second transfer device. The computer-readable program code portions still further include an executable portion configured to create a first transfer device non-fungible token for the first transfer device and a second transfer device non-fungible token for the second transfer device. The first transfer device non-fungible token indicates a portion of the one or more units of the resources indicated by the transfer request to be transmitted by the first transfer device and the second transfer device non-fungible token indicates a portion of the one or more units of the resources indicated by the transfer request to be transmitted by the second transfer device. A cumulative of the resource indicated by the first transfer device non-fungible token and the second transfer device non-fungible token are less than or equal to the one or more units of the resource indicated by the transfer request.

In various embodiments, the computer program product further includes an executable portion configured to determine one or more additional transfer device in an instance in which the cumulative of the resource indicated by the first transfer device non-fungible token and the second transfer device non-fungible token are less than the one or more units of the resource indicated by the transfer request.

In various embodiments, the computer program product further includes an executable portion configured to create an additional transfer device non-fungible token for each of the one or more additional transfer device with each additional transfer device non-fungible token including a number of units of the resource to be transferred.

In various embodiments, the computer program product further includes an executable portion configured to cause a transmission of the first transfer device non-fungible token to the first transfer device and a transmission of the second transfer device non-fungible token to the second transfer device. In various embodiments, the computer program product further includes an executable portion configured to cause a transfer of the resource to the user at the first transfer device based on the first transfer device non-fungible token.

In various embodiments, the computer program product further includes the first transfer device non-fungible token and the second transfer device non-fungible token are accessible to the first transfer device and the second transfer device across a distributed network.

In various embodiments, the computer program product further includes an executable portion configured to cause a transmission of an access code to a device associated with the user to be used to access at least one of the first transfer device or the second transfer device with the access code corresponding to at least one of the first transfer device non-fungible token or the second transfer device non-fungible token.

In still another example embodiment, a computer-implemented method for generating individual records across multiple devices via an ultra-wideband connection is provided. The method includes receiving a transfer request associated with a user. The transfer request includes a request for a one or more units of a resource from an account associated with the user. The method also includes determining a first transfer device based on a location of the user. A first transfer device amount corresponds to an amount of the resource available for transfer from the first transfer device. The method further includes determining a second transfer device based on the location of the user in an instance in which the first transfer device amount of the resource is less than the one or more units of the resource indicated by the transfer request. A second transfer device amount corresponds to an amount of the resource available for transfer from the second transfer device. The method still further includes creating a first transfer device non-fungible token for the first transfer device and a second transfer device non-fungible token for the second transfer device. The first transfer device non-fungible token indicates a portion of the one or more units of the resources indicated by the transfer request to be transmitted by the first transfer device and the second transfer device non-fungible token indicates a portion of the one or more units of the resources indicated by the transfer request to be transmitted by the second transfer device. A cumulative of the resource indicated by the first transfer device non-fungible token and the second transfer device non-fungible token are less than or equal to the one or more units of the resource indicated by the transfer request.

In various embodiments, the method also includes determining one or more additional transfer device in an instance in which the cumulative of the resource indicated by the first transfer device non-fungible token and the second transfer device non-fungible token are less than the one or more units of the resource indicated by the transfer request.

In various embodiments, the method also includes creating an additional transfer device non-fungible token for each of the one or more additional transfer device with each additional transfer device non-fungible token including a number of units of the resource to be transferred.

In various embodiments, the method also includes causing a transmission of the first transfer device non-fungible token to the first transfer device and a transmission of the second transfer device non-fungible token to the second transfer device. In various embodiments, the first transfer device non-fungible token and the second transfer device non-fungible token are accessible to the first transfer device and the second transfer device across a distributed network.

In various embodiments, the method also includes causing a transmission of an access code to a device associated with the user to be used to access at least one of the first transfer device or the second transfer device with the access code corresponding to at least one of the first transfer device non-fungible token or the second transfer device non-fungible token.

The features, functions, and advantages that have been discussed may be achieved independently in various embodiments of the present disclosure or may be combined with yet other embodiments, further details of which can be seen with reference to the following description and drawings.

### BRIEF DESCRIPTION OF THE DRAWINGS

Having described certain example embodiments of the present disclosure in general terms above, reference will now be made to the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for generating individual records across multiple devices via an ultra-wideband connection, in accordance with various embodiments of the present disclosure;

FIG. 2A illustrates an exemplary process of creating a non-fungible token (“NFT”), in accordance with various embodiments of the present disclosure;

FIG. 2B illustrates an example NFT as a multi-layered documentation of a resource, in accordance with various embodiments of the present disclosure;

FIGS. 3A-3B illustrate an exemplary distributed ledger technology (DLT) architecture, in accordance with various embodiments of the present disclosure;

FIGS. 4A and 4B illustrate a process flow for generating individual records across multiple devices via an ultra-wideband connection, in accordance with various embodiments of the present disclosure; and

FIG. 5 illustrates another process flow for generating individual records across multiple devices via an ultra-wideband connection, in accordance with various embodiments of the present disclosure.

### DETAILED DESCRIPTION

Embodiments of the present disclosure will now be described more fully hereinafter with reference to the accompanying drawings, in which some, but not all, embodiments of the disclosure are shown. Indeed, the various inventions may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of an application, or part of an application that serves as a foundation for a larger piece of software and drives the functionality of the software. In some embodiments, an engine may be self-contained, but externally-controllable code that encapsulates powerful logic designed to perform or execute a specific type of function. In one aspect, an engine may be underlying source code that establishes file hierarchy, input and output methods, and how a specific part of an application interacts or communicates with other software and/or hardware. The specific components of an engine may vary based on the needs of the specific application as part of the larger piece of software. In some embodiments, an engine may be configured to retrieve resources created in other applications, which may then be ported into the engine for use during specific operational aspects of the engine. An engine may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure, and positioning (distal phalanges, intermediate phalanges, proximal phalanges, and the like)), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, a “non-fungible token” (referred to herein as an “NFT” or “token”) is a cryptographic record linked to a resource. An NFT is typically stored on a distributed ledger that certifies ownership and authenticity of the resource, and exchangeable in a peer-to-peer network.

Singular devices may not be able to handle transfer requests. For example, automated teller machines (ATMs) may only carry a finite amount of resources, such as cash. As such, a user may not be able to complete a transfer at a nearby machine. Currently, the user would be informed that the transfer could not be completed due to a lack of resources. However, often transfer devices could potentially complete a portion of the transfer request instead of merely rejecting the transfer request.

Various embodiments of the present disclosure provide for generating individual records across multiple devices via an ultra-wideband connection. The system determines whether nearby transfer devices (e.g., an ATM) is capable of completing a transfer request. To do this, the system determines the number of resources available at a first transfer device (e.g., the closest ATM to the user) and in an instance in which the first transfer device is only capable of partially completing the transfer request, the system is configured to determine one or more additional transfer devices based on the location of the user to complete the transfer request. To complete the multiple transfers at multiple devices, the system is configured to create a non-fungible token corresponding to each of the transfer devices. Each non-fungible token indicates the amount of a resource to be transferred from the given transfer device. The user can then go to each transfer device and complete the transfer request.

Additional embodiments of the present disclosure may use individual non-fungible tokens to divide other transfer types (e.g., a group dining receipt). In such an embodiment, each device of a user may be assigned an individual non-fungible token that corresponds to the portion of the total transfer of the user. As such, each end-point device that opts in at a table may have an individual non-fungible token created. In such an embodiment, the end-point devices may communicate via ultra-wideband communication (e.g., a restaurant or other transfer location may have an ultra-wideband beacon positioned to communicate with ultra-wideband enabled end-point devices). Various types of communication may be used.

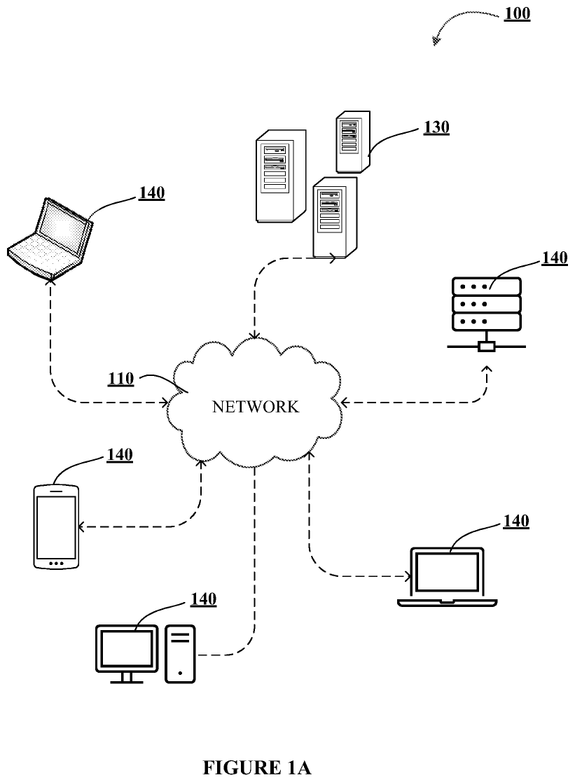

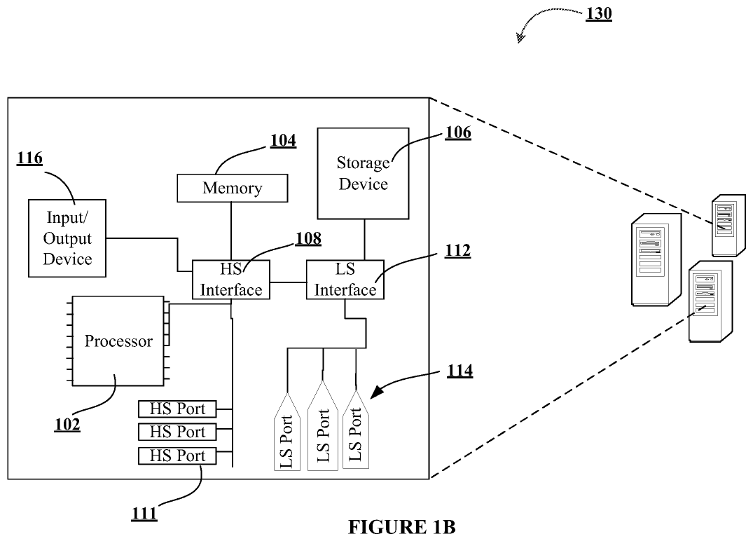

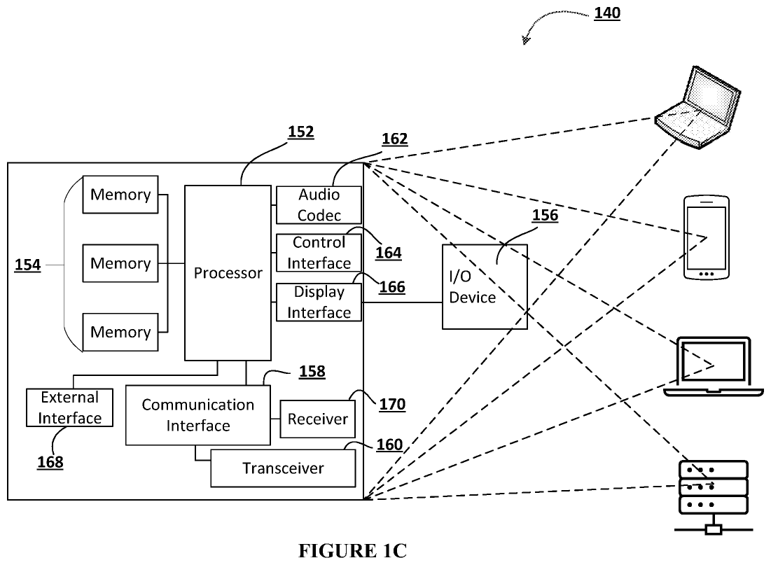

FIGS. 1A-1C illustrate technical components of an exemplary distributed computing environment for generating individual records across multiple devices via an ultra-wideband connection, in accordance with an embodiment of the disclosure. As shown in FIG. 1A, the distributed computing environment 100 contemplated herein may include a system 130 (i.e., an individual record generating system), an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

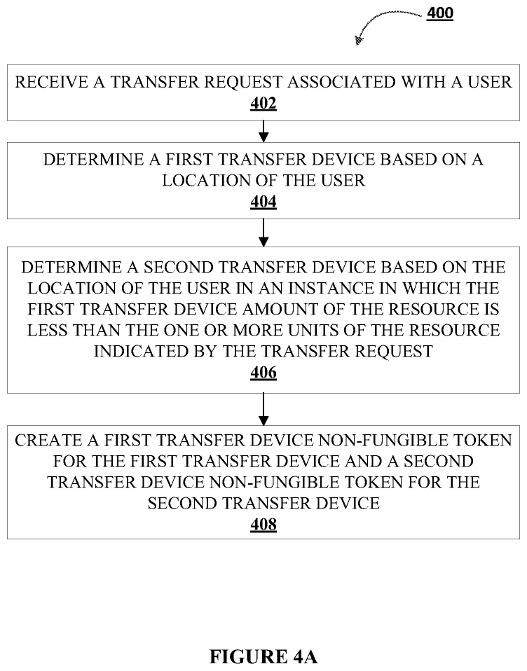

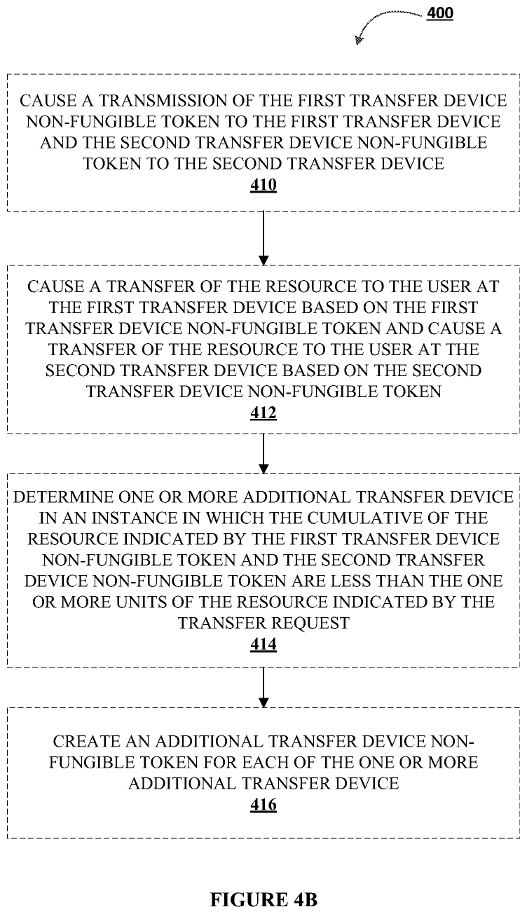

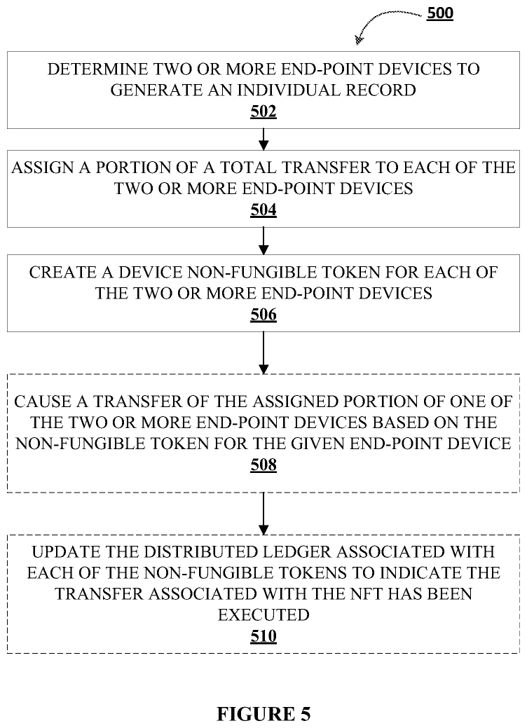

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like. In various embodiments, the end-point devices 140 may have wireless communication capabilities, such as ultra-wideband communication. In various embodiments, as discussed in reference to FIGS. 4A, 4B, and 5 below, an end-point device may include the transfer device(s) and/or the end-point device(s). For example, the end-point device of FIG. 5 may be a mobile device and the transfer device of FIGS. 4A and 4B may be an ATM.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology. Additionally, the network 110 may include a wireless communication network, such as an ultra-wideband communication network. In various embodiments, the network 110 may have one or more communication beacons that are configured to communicate with various components connected to the network. The communication beacon(s) may use ultra-wideband communication. In various embodiments, the system and the communication beacon(s) may be controlled by the same or related entities. In some embodiments, the communication beacon(s) may be connected to and/or controlled by the system 130.

It is to be understood that the structure of the distributed computing environment and its components, connections and relationships, and their functions, are meant to be exemplary only, and are not meant to limit implementations of the disclosure described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 106. The system 130 may also include a high-speed interface 108 connecting to the memory 104, and a low-speed interface 112 (shown as “LS Interface”) connecting to low-speed expansion port 114 (shown as “LS Port”) and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 106, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 106, or memory on processor 102.

The high-speed interface 108 manages bandwidth-intensive operations for the system 130, while the low-speed interface 112 manages lower bandwidth-intensive operations. Such allocation of functions is exemplary only. In some embodiments, the high-speed interface 108 (shown as “HS Interface”) is coupled to memory 104, input/output (I/O) device 116 (e.g., through a graphics processor or accelerator), and to high-speed expansion ports 111 (shown as “HS Port”), which may accept various expansion cards (not shown). In such an implementation, low-speed interface 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter. Additionally, the system 130 may have ultra-wideband communication functionality.

The system 130 may be implemented in a number of different forms. For example, it may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a micro-drive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single in Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation—and location-related wireless data to end-point device(s) 140, which may be used as appropriate by applications running thereon, and in some embodiments, one or more applications operating on the system 130. Additionally, the end-point device(s) 140 may have ultra-wideband communication functionality.

The end-point device(s) 140 may also communicate audibly using audio codec 162, which may receive spoken information from a user and convert it to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

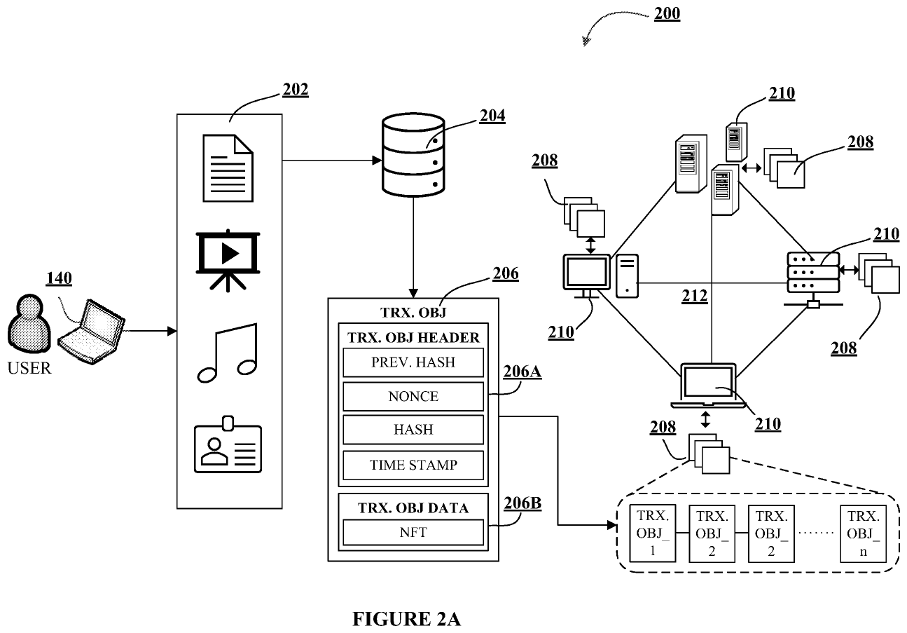

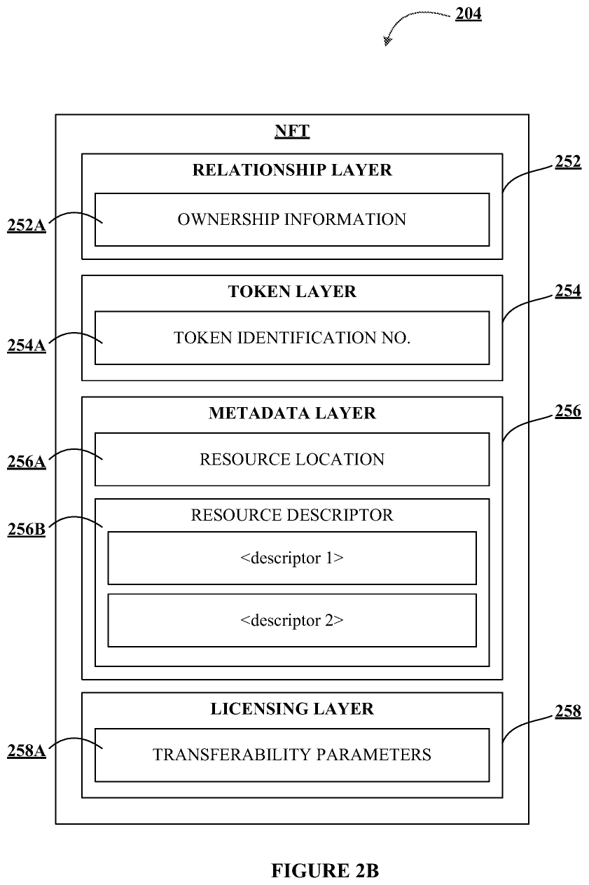

FIG. 2A illustrates an exemplary process of creating an NFT 200, in accordance with various embodiments of the present disclosure. As shown in FIG. 2A, to create or “mint” an NFT, a user may identify, using an end-point device 140, NFT resources 202 that the user wishes to mint as an NFT. Typically, NFTs are minted from digital objects that represent both tangible and intangible objects. These NFT resources 202 may include information relating to resources to be transferred (e.g., amounts relating to a resource transfer). These NFT resources 202 are then digitized into a proper format to produce an NFT 204. The NFT 204 may be a multi-layered documentation that identifies the NFT resources 202 but also evidences various transaction conditions associated therewith, as described in more detail with respect to FIG. 2A.

To record the NFT in a distributed ledger, a transaction object 206 for the NFT 204 is created. The transaction object 206 may include a transaction header 206A and a transaction object data 206B. The transaction header 206A may include a cryptographic hash of the previous transaction object, a nonce—a randomly generated 32-bit whole number when the transaction object is created, cryptographic hash of the current transaction object wedded to the nonce, and a time stamp. The transaction object data 206B may include the NFT 204 being recorded. Once the transaction object 206 is generated, the NFT 204 is considered signed and forever tied to its nonce and hash. The transaction object 206 is then deployed in the distributed ledger 208. At this time, a distributed ledger address is generated for the transaction object 206, i.e., an indication of where it is located on the distributed ledger 208 and captured for recording purposes. Once deployed, the NFT 204 is linked permanently to its hash and the distributed ledger 208, and is considered recorded in the distributed ledger 208, thus concluding the minting process.

As shown in FIG. 2A, the distributed ledger 208 may be maintained on multiple devices (nodes) 210 that are authorized to keep track of the distributed ledger 208. For example, these nodes 210 may be computing devices such as system 130 and end-point device(s) 140. One node 210 may have a complete or partial copy of the entire distributed ledger 208 or set of transactions and/or transaction objects on the distributed ledger 208. Transactions, such as the creation and recordation of a NFT, are initiated at a node and communicated to the various nodes. Any of the nodes can validate a transaction, record the transaction to its copy of the distributed ledger, and/or broadcast the transaction, its validation (in the form of a transaction object) and/or other data to other nodes.

FIG. 2B illustrates an exemplary NFT 204 as a multi-layered documentation of a resource, in accordance with various embodiments of the present disclosure. As shown in FIG. 2B, the NFT may include at least relationship layer 252, a token layer 254, a metadata layer 256, and a licensing layer 258. The relationship layer 252 may include ownership information 252A, including a map of various users that are associated with the resource and/or the NFT 204, and their relationship to one another. For example, an entity may own the non-transferrable NFT minted as discussed herein and entities (e.g., a third party entity with a node on the distributed network that is using the authentication methods discussed herein) that access, copy, etc. the NFT are logged creating a relationship that is stored in the relationship layer 252. The token layer 254 may include a token identification number 254A that is used to identify the NFT 204. The metadata layer 256 may include at least a file location 256A and a file descriptor 256B. The file location 256A may provide information associated with the specific location of the resource 202. Depending on the conditions listed in the smart contract underlying the distributed ledger 208, the resource 202 may be stored on-chain, i.e., directly on the distributed ledger 208 along with the NFT 204, or off-chain, i.e., in an external storage location. The file location 256A identifies where the resource 202 is stored. The file descriptor 256B may include specific information associated with the source itself 202. For example, the file descriptor 256B may include information about the supply, authenticity, lineage, provenance of the resource 202. The licensing layer 258 may include any transferability parameters 258B associated with the NFT 204, such as restrictions and licensing rules associated with purchase, sale, and any other types of transfer of the resource 202 and/or the NFT 204 from one person to another. Those skilled in the art will appreciate that various additional layers and combinations of layers can be configured as needed without departing from the scope and spirit of the disclosure.

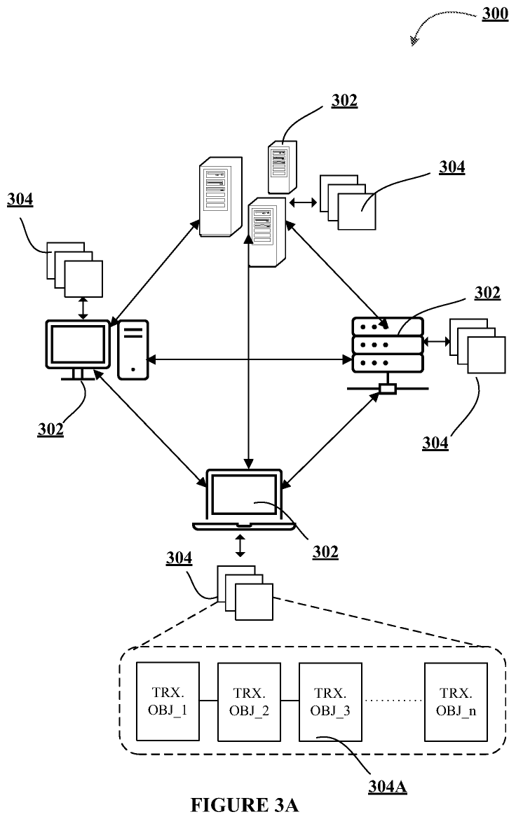

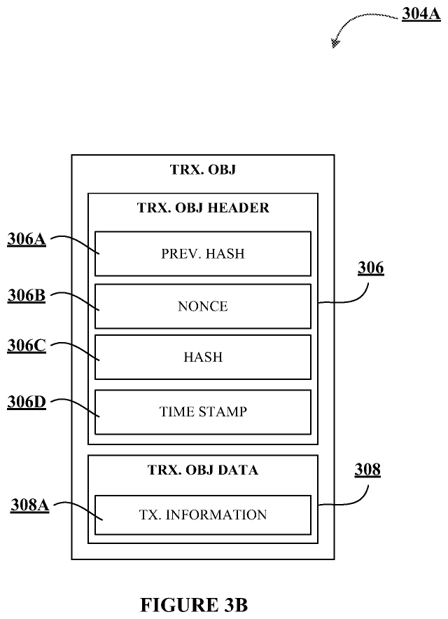

FIGS. 3A-3B illustrate an exemplary distributed ledger technology (DLT) architecture, in accordance with various embodiments of the present disclosure. The example DLT shown in FIGS. 3A-3B may be used in connection with the NFT technology discussed in reference to FIGS. 2A-2B. DLT may refer to the protocols and supporting infrastructure that allow computing devices (peers) in different locations to propose and validate transactions and update records in a synchronized way across a network. Accordingly, DLT is based on a decentralized model, in which these peers collaborate and build trust over the network. To this end, DLT involves the use of potentially peer-to-peer protocol for a cryptographically secured distributed ledger of transactions represented as transaction objects that are linked. As transaction objects each contain information about the transaction object previous to it, they are linked with each additional transaction object, reinforcing the ones before it. Therefore, distributed ledgers are resistant to modification of their data because once recorded, the data in any given transaction object cannot be altered retroactively without altering all subsequent transaction objects.

To permit transactions and agreements to be carried, as well as generally allowing information to be accessed) out among various peers without the need for a central authority or external enforcement mechanism, DLT uses smart contracts. Smart contracts are computer code that automatically executes all or parts of an agreement and is stored on a DLT platform. The code can either be the sole manifestation of the agreement between the parties or might complement a traditional text-based contract and execute certain provisions, such as transferring funds from Party A to Party B. The code itself is replicated across multiple nodes (peers) and, therefore, benefits from the security, permanence, and immutability that a distributed ledger offers. That replication also means that as each new transaction object is added to the distributed ledger, the code is, in effect, executed. If the parties have indicated, by initiating a transaction, that certain parameters have been met, the code will execute the step triggered by those parameters. If no such transaction has been initiated, the code will not take any steps.

Various other specific-purpose implementations of distributed ledgers have been developed. These include distributed domain name management, decentralized crowd-funding, synchronous/asynchronous communication, decentralized real-time ride sharing and even a general purpose deployment of decentralized applications. In some embodiments, a distributed ledger may be characterized as a public distributed ledger, a consortium distributed ledger, or a private distributed ledger. A public distributed ledger is a distributed ledger that anyone in the world can read, anyone in the world can send transactions to and expect to see them included if they are valid, and anyone in the world can participate in the consensus process for determining which transaction objects get added to the distributed ledger and what the current state each transaction object is. A public distributed ledger is generally considered to be fully decentralized. On the other hand, fully private distributed ledger is a distributed ledger whereby permissions are kept centralized with one entity. The permissions may be public or restricted to an arbitrary extent. And lastly, a consortium distributed ledger is a distributed ledger where the consensus process is controlled by a pre-selected set of nodes; for example, a distributed ledger may be associated with a number of member institutions (e.g., 15 member institutions), each of which operate in such a way that the at least 10 members must sign every transaction object in order for the transaction object to be valid. The right to read such a distributed ledger may be public or restricted to the participants. These distributed ledgers may be considered partially decentralized.

As shown in FIG. 3A, the exemplary DLT architecture 300 includes a distributed ledger 304 being maintained on multiple devices (nodes) 302 that are authorized to keep track of the distributed ledger 304. For example, these nodes 302 may be computing devices such as system 130 and end-point device(s) 140. One node 302 in the DLT architecture 300 may have a complete or partial copy of the entire distributed ledger 304 or set of transactions and/or transaction objects 304A on the distributed ledger 304. Transactions are initiated at a node and communicated to the various nodes in the DLT architecture. Any of the nodes can validate a transaction, record the transaction to its copy of the distributed ledger, and/or broadcast the transaction, its validation (in the form of a transaction object) and/or other data to other nodes.

As shown in FIG. 3B, an exemplary transaction object 304A may include a transaction header 306 and a transaction object data 308. The transaction header 306 may include a cryptographic hash of the previous transaction object 306A, a nonce 306B—a randomly generated 32-bit whole number when the transaction object is created, cryptographic hash of the current transaction object 306C wedded to the nonce 306B, and a time stamp 306D. The transaction object data 308 may include transaction information 308A being recorded. Once the transaction object 304A is generated, the transaction information 308A is considered signed and forever tied to its nonce 306B and hash 306C. Once generated, the transaction object 304A is then deployed on the distributed ledger 304. At this time, a distributed ledger address is generated for the transaction object 304A, i.e., an indication of where it is located on the distributed ledger 304 and captured for recording purposes. Once deployed, the transaction information 308A is considered recorded in the distributed ledger 304.

FIGS. 4A and 4B are a flow chart 400 that illustrates another example method of generating individual records across multiple devices via an ultra-wideband connection. The method may be carried out by various components of the distributed computing environment 100 discussed herein (e.g., the system 130, one or more end-point devices 140, etc.). An example system may include at least one non-transitory storage device and at least one processing device coupled to the at least one non-transitory storage device. In such an embodiment, the at least one processing device is configured to carry out the method discussed herein. FIG. 4B includes optional features of the method of FIG. 4A, as discussed herein.

Referring now to Block 402 of FIG. 4A, the method includes receiving a transfer request associated with a user. The transfer request may include a request for a one or more units of a resource from an account associated with the user. In various embodiments, the transfer request may also include various other transfers, such as a payment. For example, a transfer request may be related to a transaction.

In various embodiments, the transfer request may be a withdrawal request for a user from a nearby ATM. In such an instance, the system may determine one or more transfer devices (e.g., ATMs) that are capable of executing the transfer. In various embodiments, the transfer request includes the amount of the resource to be transferred (e.g., the amount of money to be withdrawn). Individual transfer devices typically have a finite number of resources to dispense and therefore may not be able to fulfil every transfer request, even ones that a user may otherwise be capable of completing. As such, the operations herein provide a method of completing large scale transfers across multiple transfer devices.

Referring now to Block 404 of FIG. 4A, the method includes determining a first transfer device based on a location of the user. The first transfer device may be determined based on the location of the user (e.g., the closest transfer device to a device associated with the user). The first transfer device (and subsequent transfer devices) may be determined using ultra-wideband communication (e.g., the end-point device of a user may communicate with one or more transfer devices via the ultra-wideband communication). Additionally, the location of one or more transfer devices may also be determined via wireless network communication (e.g., ultra-wideband communication).

The system may receive or otherwise have access to a first transfer device amount relating to the first transfer device. The first transfer device amount corresponds to an amount of the resource available for transfer from the first transfer device. For example, the first transfer device may have a certain amount of money available for transfer at a given time. The first transfer device amount may be the total amount of the resource available for transfer. Alternatively, the first transfer device amount may be a percentage of the total amount of resources available (e.g., the first transfer device may maintain a minimum resource amount to provide typical daily operations).

Referring now to Block 406 of FIG. 4A, the method includes determining a second transfer device based on the location of the user in an instance in which the first transfer device amount of the resource is less than the one or more units of the resource indicated by the transfer request. The second transfer device may also be selected based on the location of the user (e.g., the second closest transfer device to a device associated with the user). The system may receive or otherwise have access to a second transfer device amount relating to the second transfer device. A second transfer device amount corresponds to an amount of the resource available for transfer from the second transfer device.

The second transfer device may be determined in an instance in which the transfer amount indicated by the transfer request is greater than the first transfer device amount. In some embodiments, the amount available for transfer in the second transfer device may also be compared to the total transfer request and in an instance in which the second transfer device is capable of completing the transfer request, the user may be directed to the second transfer device (e.g., the entire transfer may be completed at the second transfer device). However, in an instance in which the second transfer device also has an available resource amount less than the total transfer request, the system may instruct the user to go to both the first transfer device and the second transfer device to complete the transfer. For example, the user may receive a first portion of the total transfer request from the first transfer device and then a second portion of the total transfer request from the second transfer device. The portions provided by each of the first transfer device and second transfer device may vary based on the configuration of the system. For example, in some embodiments, the first transfer device may transfer as much of the resource as possible (e.g., up to the total resource available for transfer in the first transfer device) and the second transfer device may transfer the remaining amount of the transfer request. Alternatively, the transfer amounts may be equally distributed between each of the first transfer device and the second transfer device.

While the operations discussed herein are directed to two transfer devices, any number of transfer devices may be used in the operations discussed herein. For example, in an instance in which the first transfer device and the second transfer device do not cumulatively have the total transfer request amount available, then a third transfer device may be used to provide additional resources to complete the transfer.

Referring now to Block 408 of FIG. 4A, the method includes creating a first transfer device non-fungible token for the first transfer device and a second transfer device non-fungible token for the second transfer device. The first transfer device non-fungible token and the second transfer device non-fungible token are created as discussed above in reference to FIGS. 2A and 2B. The first transfer device non-fungible token indicates a portion of the one or more units of the resources indicated by the transfer request to be transmitted by the first transfer device. The second transfer device non-fungible token indicates a portion of the one or more units of the resources indicated by the transfer request to be transmitted by the second transfer device.

In various embodiments, the cumulative of the resource indicated by the first transfer device non-fungible token and the second transfer device non-fungible token are less than or equal to the one or more units of the resource indicated by the transfer request. For example, the cumulative of the resource indicated by the first transfer device non-fungible token and the second transfer device non-fungible token may be the same as the one or more units of the resource indicated by the transfer request (e.g., the transfer devices cover the entire transfer request).

In various embodiments, the first transfer device non-fungible token and the second transfer device non-fungible token may be accessible to the first transfer device and the second transfer device via a distributed ledger (e.g., a distributed ledger as discussed in reference to FIGS. 3A and 3B above) over network 110. In some embodiments, information to access or find the given non-fungible token (e.g., an access code) may be provided to a device (e.g., an end-point device) associated with the user to be used to access at least one of the first transfer device or the second transfer device. In such an embodiment, the access code corresponds to at least one of the first transfer device non-fungible token or the second transfer device non-fungible token.

Referring now to optional Block 410 of FIG. 5, the method includes causing a transmission of the first transfer device non-fungible token to the first transfer device and the second transfer device non-fungible token to the second transfer device.

Upon creation of the first transfer device non-fungible token, the first transfer device non-fungible token may be transmitted to the user (e.g., an end-point device associated with the user) and/or the first transfer device. In some instances, the first transfer device non-fungible token may be stored on a distributed ledger. The user and/or the first transfer device may receive the first transfer device non-fungible token or information to allow access to the first transfer device non-fungible token (e.g., an access code, a token identifier, etc.).

Upon creation of the second transfer device non-fungible token, the second transfer device non-fungible token may be transmitted to the user (e.g., an end-point device associated with the user) and/or the second transfer device. In some instances, the second transfer device non-fungible token may be stored on a distributed ledger. The user and/or the second transfer device may receive the second transfer device non-fungible token or information to allow access to the second transfer device non-fungible token (e.g., an access code, a token identifier, etc.).

Referring now to optional Block 412 of FIG. 4B, the method includes causing a transfer of the resource to the user at the first transfer device based on the first transfer device non-fungible token and cause a transfer of the resource to the user at the second transfer device based on the second transfer device non-fungible token. The first transfer device non-fungible token indicates the amount to transfer to the user via the first transfer device. The second transfer device non-fungible token indicates the amount to transfer to the user via the second transfer device.

In various embodiments, the user (and/or end-point device of the user) may interact with the first transfer device and/or the second transfer device to initiate the transfer from the given transfer device. Such interaction may include scanning a code or image that corresponds to the given non-fungible token, notifying the given transfer device that the user has arrived via an end-point device, inputting account information, and/or the like. In various embodiments, each transfer device non-fungible token may be linked to the account of the user (e.g., the user may input account information at the first transfer device and the first transfer device non-fungible token may be retrieved based on the account information). In some embodiments, the given transfer device non-fungible token may be provided by the end-point device of the user. Additionally or alternatively, the user and/or end-point device may provide access information for the given transfer device to access the given non-fungible token.

As discussed below in reference to Block 414 of FIG. 4B, the first transfer device and the second transfer device are merely illustrative of a plurality of transfer devices being used. In various embodiments, various number of transfer devices may be used and in such an instance, a distinct non-fungible token may be generated for each transfer device as discussed herein for the first transfer device and/or the second transfer device. In various embodiments, the amount indicated by the transfer request may be provided by the plurality of transfer devices (e.g., the total amount of transfers across all transfer devices may be equal to the amount indicated by the transfer request.

Referring now to optional Block 414 of FIG. 4B, the method includes determining one or more additional transfer device in an instance in which the cumulative of the resource indicated by the first transfer device non-fungible token and the second transfer device non-fungible token are less than the one or more units of the resource indicated by the transfer request. The system may be configured to continue to find additional transfer devices until the transfer request can be completed. In some embodiments, one or more of the transfer devices may be passed over or otherwise not included in the transfer. For example, one or more of the transfer devices may have more resources available than another and therefore be more capable of handling a portion of the total transfer request.

Referring now to optional Block 416 of FIG. 4B, the method includes creating an additional transfer device non-fungible token for each of the one or more additional transfer device. Each additional transfer device non-fungible token includes a number of units of the resource to be transferred. The additional transfer device non-fungible token(s) may be created in the same fashion as the first transfer device non-fungible token and/or the second transfer device non-fungible token.

FIG. 5 is a flow chart 500 that illustrates another example method of generating individual records across multiple devices via an ultra-wideband connection. The method may be carried out by various components of the distributed computing environment 100 discussed herein (e.g., the system 130, one or more end-point devices 140, etc.). An example system may include at least one non-transitory storage device and at least one processing device coupled to the at least one non-transitory storage device. In such an embodiment, the at least one processing device is configured to carry out the method discussed herein.

Referring now to Block 502 of FIG. 5, the method includes determining two or more end-point devices to generate an individual record. Each of the end-point devices are within a given area or location. The given area or location may be within the range of one or more communication beacons, such as an ultra-wideband beacon. In an example embodiment, the given area or location may be related to an entity (e.g., a store, restaurant, meeting space, etc.). The one or more communication beacon may be located and/or controlled by the entity (e.g., a restaurant may have a communication beacon that is configured to communicate with enabled devices within the area or location.

Each end-point device communicating with the communication beacon(s) may be registered and/or approved to communicate with the communication beacon(s). For example, a user in an area or location may register an end-point device (e.g., via scanning or entering a code, connecting to a local network, etc.).

Referring now to Block 504 of FIG. 5, the method includes assigning a portion of a total transfer to each of the two or more end-point devices. The portion of the total transfer may be equal portions divided across the two or more end-point devices. Alternatively, the portion of the total transfer assigned to each of the two or more devices may be based on each of the users associated with the two or more devices.

In various embodiments, one or more of the end-point devices in communication with the communication beacon(s) may be associated with a sub-area within the area or location. The end-point device may be associated with the sub-area in which an end-point device is located. The location of the end-point device may be determined based on the communication between the communication beacon(s) and end-point device and/or by the end-point device indicating the sub-area (e.g., a user may input the table number for the end-point device).

In an example embodiment in which the area or location is a restaurant, customers may be positioned at individual tables and the end-point devices would be assigned sub-areas based on the table (e.g., each end-point device within a sub-area may be used to complete the operations of Block 504 of FIG. 5). Each sub-area may have a total transfer amount for all of the customers located in the sub-area (e.g., a total transaction amount for all of the customers at the table). As such, the total transfer amount may be split (e.g., equally or based on usage by individual users at the location) between each of the end-point devices in the given sub-area.

In various embodiments, one or more of the users and/or end-point devices in a sub-area may be confirm and/or other verify the assigned portions for each of the end-point device. Such a confirmation may include confirming the end-point devices assigned to the given sub-area, portions assigned to each end-point device, total transfer amount, etc. The confirmation may be by the user (e.g., a representative of the location may ask a user at the sub-area to confirm the split) or by the end-point device(s) of the sub-area (e.g., a user may be provided a display via the user interface of the end-point device to confirm the assigned portions of the total transfer amount). In some embodiments, one or more end-point devices within a sub-area may be assigned at the main end-point device and may have additional capabilities (e.g., approving the assigned portions of the total transfer amount).

Referring now to Block 506 of FIG. 5, the method includes creating a device non-fungible token for each of the two or more end-point devices. Each of the device non-fungible tokens is created as discussed above in reference to FIGS. 2A and 2B. Each of the device non-fungible tokens indicates the portion of the total transfer associated with the given end-point device. The created device non-fungible token may include various information relating to the transfer. For example, the device non-fungible token may include the total transfer amount, the portion of the total transfer assigned to the given end-point device, the sub-area (e.g., table) at which the end-point device was located, and/or other information relating to the transfer.

Referring now to optional Block 508 of FIG. 5, the method includes causing a transfer of the assigned portion of one of the two or more end-point devices based on the non-fungible token for the given end-point device. Upon creation of the non-fungible token for each end-point device of the total transfer, the system may be configured to cause a transmission of the non-fungible token itself and/or information relating to accessing the non-fungible token (e.g., an access code, a token address, etc.). As such, the end-point device can access or provide another device access to the non-fungible token. For example, a given end-point device may be able to pay the portion of the total transfer amount based on the non-fungible token associated with the given end-point device (e.g., the entity may allow for remote payment using the NFT).

Additionally or alternatively, the entity may have a transfer location in which the end-point device may provide the NFT and/or information relating to the NFT (e.g., a user may scan an end-point device at check-out and the portion of the total transfer can be retrieved using the NFT for the given end-point device). Upon execution of the transfer (e.g., payment), the NFT for the given end-point device may be noted and/or updated to be marked paid.

The entity with the communication beacon(s) may monitor each of the NFTs for a given sub-area until each of the end-point devices has executed the transfer (e.g., all of the table has paid for the ticket). In some instances, one or more entity NFTs may be created that are used to determine an instance in which each of the end-points devices have completed a transfer. Alternatively, the system may monitor each of the NFTs to determine when the transfer associated with each of NFTs is executed.

Referring now to optional Block 510 of FIG. 5, the method includes updating the distributed ledger associated with each of the non-fungible tokens to indicate the transfer associated with the NFT has been executed. In some instances, an additional NFT (e.g., block of the distributed ledger) may be created indicating execution of the given transfer. In such an instance, the newly created execution NFT may include information that identifies the NFT in which the executed transfer was associated. In some embodiments, an independent ledger (e.g., a distributed ledger or otherwise) may be generated that indicates the status of transfers associated with each NFT on a distributed ledger.

As will be appreciated by one of ordinary skill in the art, various embodiments of the present disclosure may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present disclosure may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present disclosure may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present disclosure, however, the computer-readable medium may be transitory, such as a propagation signal including computer-executable program code portions embodied therein.

It will also be understood that one or more computer-executable program code portions for carrying out the specialized operations of the present disclosure may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present disclosure are written in conventional procedural programming languages, such as the “C” programming languages and/or similar programming languages. The computer program code may alternatively or additionally be written in one or more multi-paradigm programming languages, such as, for example, F #.

It will further be understood that some embodiments of the present disclosure are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These computer-executable program code portions execute via the processor of the computer and/or other programmable data processing apparatus and create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present disclosure.

While certain exemplary embodiments have been described and shown in the accompanying drawings, it is to be understood that such embodiments are merely illustrative of, and not restrictive on, the broad disclosure, and that this disclosure not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the disclosure. Therefore, it is to be understood that, within the scope of the appended claims, the disclosure may be practiced other than as specifically described herein.

What is claimed is:

1. A system for generating individual records across multiple devices via an ultra-wideband connection, the system comprising:
at least one non-transitory storage device; and
at least one processing device coupled to the at least one non-transitory storage device, wherein the at least one processing device is configured to:
receive a transfer request associated with a user, wherein the transfer request comprises a request for a one or more units of a resource from an account associated with the user;
determine a first transfer device based on a location of the user, wherein a first transfer device amount corresponds to an amount of the resource available for transfer from the first transfer device;
in an instance in which the first transfer device amount of the resource is less than the one or more units of the resource indicated by the transfer request, determine a second transfer device based on the location of the user, wherein a second transfer device amount corresponds to an amount of the resource available for transfer from the second transfer device; and
create a first transfer device non-fungible token for the first transfer device and a second transfer device non-fungible token for the second transfer device,
wherein the first transfer device non-fungible token indicates a portion of the one or more units of the resources indicated by the transfer request to be transmitted by the first transfer device and the second transfer device non-fungible token indicates a portion of the one or more units of the resources indicated by the transfer request to be transmitted by the second transfer device, and
wherein a cumulative of the resource indicated by the first transfer device non-fungible token and the second transfer device non-fungible token are less than or equal to the one or more units of the resource indicated by the transfer request.

2. The system of claim 1, wherein the at least one processing device is configured to determine one or more additional transfer device in an instance in which the cumulative of the resource indicated by the first transfer device non-fungible token and the second transfer device non-fungible token are less than the one or more units of the resource indicated by the transfer request.

3. The system of claim 2, wherein the at least one processing device is configured to create an additional transfer device non-fungible token for each of the one or more additional transfer device, wherein each additional transfer device non-fungible token comprises a number of units of the resource to be transferred.

4. The system of claim 1, wherein the at least one processing device is configured to cause a transmission of the first transfer device non-fungible token to the first transfer device and a transmission of the second transfer device non-fungible token to the second transfer device.

5. The system of claim 1, wherein the at least one processing device is configured to cause a transfer of the resource to the user at the first transfer device based on the first transfer device non-fungible token.

6. The system of claim 1, wherein the first transfer device non-fungible token and the second transfer device non-fungible token are accessible to the first transfer device and the second transfer device across a distributed network.

7. The system of claim 1, wherein the at least one processing device is configured to cause a transmission of an access code to a device associated with the user to be used to access at least one of the first transfer device or the second transfer device, wherein the access code corresponds to at least one of the first transfer device non-fungible token or the second transfer device non-fungible token.

8. A computer program product for generating individual records across multiple devices via an ultra-wideband connection, the computer program product comprising at least one non-transitory computer-readable medium having computer-readable program code portions embodied therein, the computer-readable program code portions comprising:
an executable portion configured to receive a transfer request associated with a user, wherein the transfer request comprises a request for a one or more units of a resource from an account associated with the user;
an executable portion configured to determine a first transfer device based on a location of the user, wherein a first transfer device amount corresponds to an amount of the resource available for transfer from the first transfer device;
an executable portion configured to determine a second transfer device based on the location of the user in an instance in which the first transfer device amount of the resource is less than the one or more units of the resource indicated by the transfer request, wherein a second transfer device amount corresponds to an amount of the resource available for transfer from the second transfer device; and
an executable portion configured to create a first transfer device non-fungible token for the first transfer device and a second transfer device non-fungible token for the second transfer device,
wherein the first transfer device non-fungible token indicates a portion of the one or more units of the resources indicated by the transfer request to be transmitted by the first transfer device and the second transfer device non-fungible token indicates a portion of the one or more units of the resources indicated by the transfer request to be transmitted by the second transfer device, and
wherein a cumulative of the resource indicated by the first transfer device non-fungible token and the second transfer device non-fungible token are less than or equal to the one or more units of the resource indicated by the transfer request.

9. The computer program product of claim 8, wherein the computer program product further comprises an executable portion configured to determine one or more additional transfer device in an instance in which the cumulative of the resource indicated by the first transfer device non-fungible token and the second transfer device non-fungible token are less than the one or more units of the resource indicated by the transfer request.

10. The computer program product of claim 9, wherein the computer program product further comprises an executable portion configured to create an additional transfer device non-fungible token for each of the one or more additional transfer device, wherein each additional transfer device non-fungible token comprises a number of units of the resource to be transferred.

11. The computer program product of claim 8, wherein the computer program product further comprises an executable portion configured to cause a transmission of the first transfer device non-fungible token to the first transfer device and a transmission of the second transfer device non-fungible token to the second transfer device.

12. The computer program product of claim 8, wherein the computer program product further comprises an executable portion configured to cause a transfer of the resource to the user at the first transfer device based on the first transfer device non-fungible token.

13. The computer program product of claim 8, wherein the first transfer device non-fungible token and the second transfer device non-fungible token are accessible to the first transfer device and the second transfer device across a distributed network.

14. The computer program product of claim 8, wherein the computer program product further comprises an executable portion configured to cause a transmission of an access code to a device associated with the user to be used to access at least one of the first transfer device or the second transfer device, wherein the access code corresponds to at least one of the first transfer device non-fungible token or the second transfer device non-fungible token.

15. A computer-implemented method for generating individual records across multiple devices via an ultra-wideband connection, the method comprising:
receiving a transfer request associated with a user, wherein the transfer request comprises a request for a one or more units of a resource from an account associated with the user;
determining a first transfer device based on a location of the user, wherein a first transfer device amount corresponds to an amount of the resource available for transfer from the first transfer device;
in an instance in which the first transfer device amount of the resource is less than the one or more units of the resource indicated by the transfer request, determining a second transfer device based on the location of the user, wherein a second transfer device amount corresponds to an amount of the resource available for transfer from the second transfer device; and
creating a first transfer device non-fungible token for the first transfer device and a second transfer device non-fungible token for the second transfer device,
wherein the first transfer device non-fungible token indicates a portion of the one or more units of the resources indicated by the transfer request to be transmitted by the first transfer device and the second transfer device non-fungible token indicates a portion of the one or more units of the resources indicated by the transfer request to be transmitted by the second transfer device, and
wherein a cumulative of the resource indicated by the first transfer device non-fungible token and the second transfer device non-fungible token are less than or equal to the one or more units of the resource indicated by the transfer request.

16. The method of claim 15, further comprising determining one or more additional transfer device in an instance in which the cumulative of the resource indicated by the first transfer device non-fungible token and the second transfer device non-fungible token are less than the one or more units of the resource indicated by the transfer request.

17. The method of claim 16, further comprising creating an additional transfer device non-fungible token for each of the one or more additional transfer device, wherein each additional transfer device non-fungible token comprises a number of units of the resource to be transferred.

18. The method of claim 15, further comprising causing a transmission of the first transfer device non-fungible token to the first transfer device and a transmission of the second transfer device non-fungible token to the second transfer device.

19. The method of claim 15, wherein the first transfer device non-fungible token and the second transfer device non-fungible token are accessible to the first transfer device and the second transfer device across a distributed network.

20. The method of claim 15, further comprising causing a transmission of an access code to a device associated with the user to be used to access at least one of the first transfer device or the second transfer device, wherein the access code corresponds to at least one of the first transfer device non-fungible token or the second transfer device non-fungible token.
